(19) United States
(12) Patent Application Publication
(10) Pub. No.: US 2007/0118550 A1
(43) Pub. Date: May 24, 2007

(54) Method and apparatus for building a multi-discipline and multi-media personal medical image library

(76) Inventors: Guo Liang Yang, Singapore (SG); Wieslaw L. Nowinski, Singapore (SG); Choie Cheio Tchoyoson Lim, Singapore (SG); Banukumar Narayanaswami, Singapore (SG)

Correspondence Address: Blakely Sokoloff;Taylor & Zafman, 7th Floor, 12400 Wilshire Boulevard, Los Angeles, CA, 90025-1026, US

(21) Appl. No.: 10/580,776

(22) PCT Filed: Nov. 24, 2004
(86) PCT No.: PCT/SG04/00382

§ 371 Date: May 26, 2006

(30) Foreign Application Priority Data
Nov. 27, 2003 (SG) 200306928-3

(51) Int. Cl. G06F 7/00

(52) U.S. Cl. 707/102

(57) ABSTRACT

A method for retrieving medical images from various sources and in different formats, to enable the creation of teaching files and research datasets, for the building of a personal medical image library, the method comprising: retrieving a plurality of medical images from various sources; storing the plurality of medical images in a database; generating a database record for the teaching files and research datasets; generating the teaching files and research datasets file; saving the teaching files and research datasets into the database; and generating at least one index of the teaching files and research datasets.

### REFERENCE TO RELATED APPLICATION

This invention is related to the earlier U.S. patent application Ser. No. 10/307,190 filed 28 Nov. 2002 entitled “A Method and Apparatus for Creating Medical Teaching Files From Image Archives”, the contents of which are hereby incorporated by reference (the “earlier patent application”).

### FIELD OF THE INVENTION

This invention relates to a method and apparatus for building a multidiscipline and multi-media personal medical image library and refers particularly, though not exclusively, to such a method and apparatus using medical images of different formats and sources.

### ABBREVIATIONS AND ACRONYMS

Throughout this specification the following abbreviations and acronyms shall have the following meanings:
ACR: American College of Radiology
AVI: Audio Visual Interleaved
   A multi-media file format usually with the file extension .avi
BMP: Bitmap
   An image file format usually with the file extension .bmp
DICOM: Digital Imaging and Communications in Medicine
   A standard medical imaging format and protocol
DS: Dataset
   A document containing text and images that is useful for medical imaging research
GUI: Graphical User Interface
ECG: ElectroCardioGram
EEG: ElectroEncephaloGram
EMG: ElectroMyoGram
GIF: Graphic Interchange Format
   An image file format usually with the file extension .gif
HTTP: Hyper Text Transfer Protocol
   An application-level protocol for distributed, collaborative, hypermedia information systems
ID: Identifier
   A string used to identify a patient or a study in DICOM protocol
JPEG: Joint Photographic Experts Group
   An image format usually with the file extension jpg or jpeg
MIRC: Medical Imaging Resource Center
   A distributed medical imaging repository and standard defined by RSNA
MIRIP: Medical Imaging Repository Interfacing with PACS
   The name of the system based on the method disclosed in the earlier patent application
MOV: Movie
   A multi-media file format usually with the file extension .mov
MP3: MPEG (Moving Picture Experts Group) (audio layer) 3
   A multi-media file format usually with the file extension .mp3
PACS: Picture Archiving and Communication System
   The clinical image archive
PMIL: Personal Medical Image Library
   The name of the system utilized the method and apparatus of the present invention
PNG: Portable Network Graphic
   An image file format usually with the file extension .png
RM: Real Media
   A multi-media file format usually with the file extension .rm
RSNA: Radiological Society of North America
RGB: Red Green Blue
   An image file format usually with the file extension .rgb
RGBA: Red Green Blue Alpha
   An image file format usually with file extension .rgba
SGI: Silicon Graphic Incorporation
   An image file format usually with file extension .sgi
TF: Teaching File
   A document containing text and images that is useful for medical education
TIFF: Tagged Image File Format
   An image file format usually with file extension .tif or .tiff
UID: Unique Identifier
   A number that uniquely identifies an object in the DICOM standard
XML: Extensible Markup Language
   Defined by the World Wide Web Consortium (W3C).

### BACKGROUND OF THE INVENTION

Medical (e.g. radiology, pathology, endoscopy, and so forth) images are important building blocks for clinical support, teaching and research. In the digital environment, medical images may be organized and cross-referenced in a powerful and interactive fashion. As more clinicians use digitized images, a personal medical image library Will become a valuable tool for on-demand learning, research, and exchange of data. However, a solution does not yet exist to build such a library that can collect and store medical images of various disciplines and formats. Medical Imaging Resource Center (MIRC), which was developed in 2001, is a standardized platform for exchanging image data.

Many clinicians from all kinds of disciplines have their own hardcopy medical image collections for archive, teaching and research. But there is no open standard for them to organize and share them. Recently, the Radiological Society of North America has defined standards for Medical Image Resource Center. MIRC has the potential to be a worldwide set of standards defining teaching file and research data sets in the same fashion as DICOM has become the de facto standard for PACS.

There are no known systems for obtaining medical images and other information from various sources to compose radiological teaching files and research datasets in a personal file library able to be shared with other libraries using the MIRC protocol.

### SUMMARY OF THE INVENTION

In accordance with a preferred aspect of the invention there is provided a method for retrieving medical images from various sources and in different formats, to enable the creation of teaching files and research datasets, for the building of a personal medical image library, the method comprising:
(a) retrieving a plurality of medical images from various sources;
(b) storing the plurality of medical images in a database;
(c) generating a database record for the teaching files- and research datasets;
(d) generating the teaching files and research datasets file;
(e) saving the teaching files and research datasets into the database; and
(f) generating at least one index of the teaching files and research datasets.

The method may further include a searching mechanism for searching the teaching files and research datasets.

The medical images may be from at least one discipline selected from: radiology, nuclear medicine, dermatology, pathology, ophthalmology, cardiology, neurology, endoscopy, angiography, biomedicine, ECG, EEG, and EMG.

Preferably, the method is in accordance with MIRC schema.

The method may further include anonymizing patient sensitive information, the patient sensitive information being able to be revealed to a generator of the teaching files and research datasets. Preferably, the patient sensitive information is not revealed publicly. The anonymization process may include the replacing of each item of the sensitive information with an anonymization code. The anonymization code may include a prefix, a randomly generated number, and a type. The prefix may be a short string of characters representing the generator of the sensitive information; and the type may represent the nature of the sensitive information.

A check may first be performed to determine if the item of sensitive information has previously been anonymized and the anonymization code previously generated; and, if yes, retrieving and using the previously generated anonymization code.

The sensitive information may include one or more of: patient's name, patient ID, other patient's names, other patient IDs, patient's birth name, patient's address, patient's telephone numbers, patient's mother's birth name, region of residence, country of residence, military rank, branch of service, patient comments, additional patient history, referring physician's name, referring physician's address, referring physician's telephone numbers, and all other person names.

In step (c), ACR codes may be entered as a result of system prompts. The ACR codes may be used for the at least one index of the teaching files.

Indexing may be by at least one of: title, abstract,- keywords, authors, affiliations, contacts, patient information, radiological codes, image format, image compression status, image modality, anatomic location, and ACR codes.

For internal searching, patient sensitive information may be revealed, and for external searching patient sensitive information may be anonymized.

In accordance with a second aspect of the invention there is provided apparatus for retrieving medical images from various sources and in various formats for creating at least one teaching file and research dataset; the apparatus including a database, an image retrieval interface able to retrieve medical images from various sources and in different formats, an MIRC server, a server, and a graphic user interface for operation on a users machine.

The database is preferably a relational database for storage of all required information, including: database tables; database indexes; database scripts; and pointers to the medical images, teaching files and research datasets.

The server preferably serves requests received from a user via the graphic user interface on a users machine; the graphic user interface being for providing access functions and file editing functions.

The image server may include at least one of: a two dimensional image loader, a three dimensional image loader, a multi-media loader, and a telemetry loader.

The two-dimensional image loader is for retrieving two-dimensional still images, the three-dimensional image loader is for retrieving three-dimensional still images; the multi-media loader is for retrieving multi-media files; and the telemetry loader is for retrieving telemetry data.

The graphic user interface may include a PMIL client as a user interface able to run in a web browser or as a stand alone application on a user's machine, and provides MIRC editing functions.

The server may include an MIRC storage for providing an MIRC file storage service for the database and for the user's machine. The MIRC server may further include an MIRC query to provide queries as defined by the MIRC scheme.

The at least one teaching file may be in accordance with a Medical Imaging Resource Centre standard.

In a final aspect of the invention there is provided a computer useable medium comprising a computer program code that is configured to cause a processor to execute one or more functions to perform the method outlined above.

### BRIEF OF THE DRAWINGS

In order that the invention may be fully understood and readily put into practical effect there shall now be described by way of non-limitative example only preferred embodiments of the invention, the description being with reference to the accompanying illustrative drawings in which:

FIG. 1 is a system block diagram that illustrates the main components of the apparatus;

FIG. 2 is a detailed structural diagram that illustrates in more detail the components of the apparatus of FIG. 1;

FIG. 3 is a system flowchart that illustrates the steps to create teaching files and research datasets from medical images and other information;

FIG. 4 is a flowchart for anonymizing sensitive information;

FIG. 5 is a flowchart for anonymizing a DICOM image; and

FIG. 6 is a flowchart of input ACR code.

### DETAILED DESCRIPTION OF PREFERRED EMBODIMENTS

This system serves as a personal medical image library that stores and organizes medical images and metadata in a database, it can also be used to exchange image data in the global MIRC community.

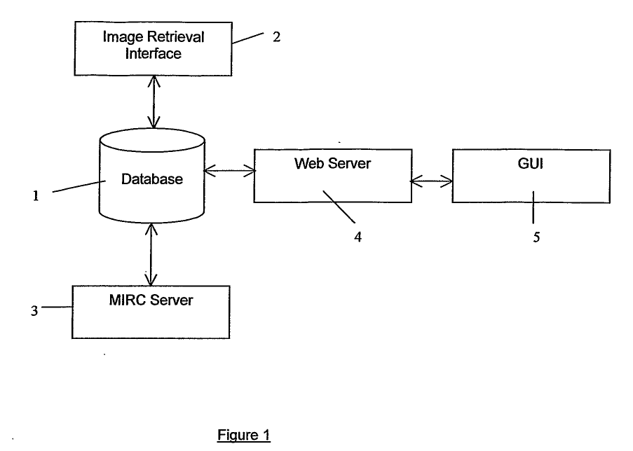

As shown in FIG. 1 the system includes a database 1, an image retrieval interface 2, a MIRC server 3, a web server 4, and a GUI 5.

The database 1 is preferably a relational database. The database 1 stores all information for the system, including database tables, database indexes, and database scripts; and also stores the pointers to the physical files of the system.

The image retrieval interface 2 is able to retrieve images of various disciplines and formats. The MIRC server 3 provides MIRC compliant functions, including MIRC query and MIRC storage.

The Web server 4 services the various requests of the GUI, and the GUI 5 provides functions to access the system. GUI 5 also provides MIRC file editing functions.

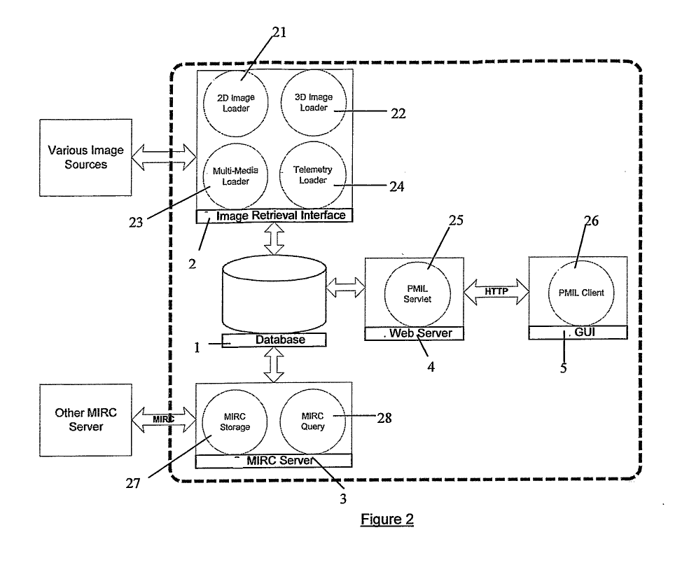

A more detailed structure is illustrated in FIG. 2. The images retrieval interface 2 includes a two dimensional image loader 21 that is used to retrieve 2-dimensional still images; a three dimensional image loader 22 that is used to retrieve 3-dimensional still images; a multi-media loader 23 that is used to retrieve multi-media files; and a telemetry loader 24 that is used to retrieve telemetry data.

The web server 4 includes a PMIL servlet 25 running in the web server 4 to serve requests from the GUI 5.

The GUI 5 includes a PMIL client 26 as the user interface. The PMIL client 26 can be run in a web browser or as a stand alone application.

The MIRC server 3 includes a MIRC storage 27 that provides MIRC teaching file storage service; and an MIRC query 28 provides queries as defined by the MIRC schema.

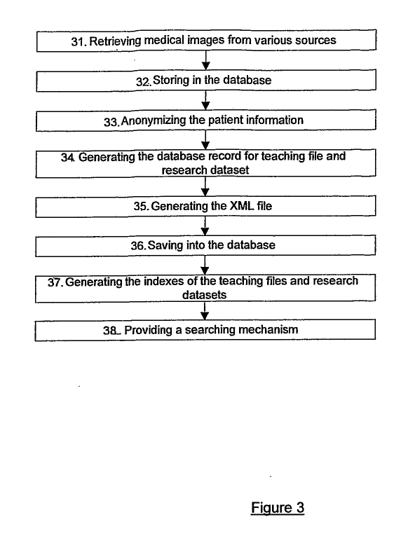

As shown in FIG. 3, the method for retrieving medical images comprises the steps of retrieving the medical images (31) from various sources and in different formats. The images may be in any number of formats. The images are then stored in the database 1 (32) and the patient information is anonymized (33). The database record for the teaching file or research dataset is then generated (34) and an XML file generated (35). The XML file is then saved into the database 1 (36). Indexes of the teaching files and research datasets are generated (37) and a searching mechanism is provided (38). The searching mechanism may be any known, appropriate database searching engine or application.

Different departments of a hospital generate a large number of medical images for various diagnosis purposes. Most images are in digital format, and are stored in digital media. Some images are typical or atypical; they are particularly suitable teaching and research.

The first step of retrieving medical images (31) involves reading medical images stored in digital media. Various way of reading images are used including, but not limited to:
Open a single file from disk
Open multiple files from disk
Copy image from clipboard
Capture image from computer screen
Drag a single file into the system
Drag multiple files into the system
Drag a single folder into the system
Drag multiple folders into the system

Different image formats may be supported including, but not limited to:
2-Dimensional Still images
   AVW, HDR/IMG (Analyze format: version 8.0 and 7.5)
   BMP (Windows Bitmap format)
   DICOM (Digital Imaging and Communications in Medicine)
   GIF
   JPEG
   JPEG 2000
   PNG
   PNM
   PPG
   RGB
   RGBA
   SGI
   TIFF
3-Dimensional Still Images
   AVW, HDR/IMG (Analyze format: version 8.0 and 7.5)
   Animated GIF
   MIRA
   Muti-sliced TIFF
Multi-Media audio and video:
   MOV
   AVI
   MP3
   RM
Telemetry
   Waveform for ECG, EEG, EMG

For all supported formats, the relevant application for dealing with the format is provided, and is fully integrated into the operating system. All images are kept in their original format once retrieved. For two-dimensional images, two additional JPEG images may be generated for ease of browsing using a web browser. These additional images may be of the same size as the thumbnail images. For other image formats, an additional thumbnail image may be generated.

When images are loaded from the open image dialogue, all supported images can be previewed in the dialogue, before they are actually loaded. In this way it is possible to load images of interest.

In step 32, after the images are loaded, then can be viewed in the image window and selected to add into teaching files and research datasets, and further stored in the database (1).

Since medical images are usually large in size, they need a large amount of disk space to store. The image storage may be spanned to multiple storage media. When the current storage media in use is approaching being filled, a storage media with sufficient free space is located and subsequently used.

Patient specific information retrieved from the clinical image archive is very sensitive and can only be referenced internally. It is not allowed to appear in teaching files and datasets, which may be published. Patient sensitive information can't be simply removed from the teaching files. Sometimes it is required to be able refer back to the actual patient. Therefore, patient sensitive information needs to be anonymized. There are two places where patient information may appear: in the database record and in DICOM files.

In the database record, the patient name and ID are stored. The process described below may be used to anonymize them.

The anonymization process has the format of:
<Prefix><Type>−<Number>
Where, prefix is usually a small number of letters. The letters may represent the creator of the anonymized information. Typically, the letters may be the acronym of the creating institute such as, for example, “BIL”.

Type specifies the nature of the anonymized information. Since patient name and ID are most frequently referenced, a “P” and a “D” may be used to represent them respectively. An “X” may be used to represent all other types of information. Further classification is also possible, for example, an “A” can be used to represent address information.

Number is a random number uniquely generated to distinguish the anonymized code from other codes.

For example, a code, “BILP-3388”, represents a patient name, is created by an organization named “BIL”.

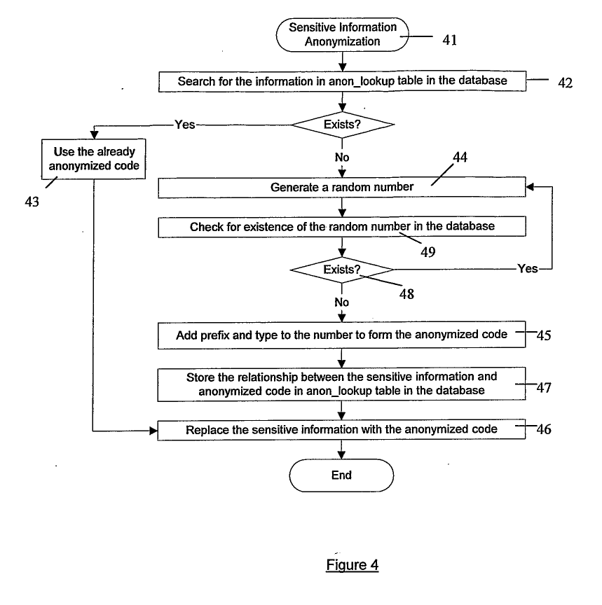

As shown in FIG. 4, the following process steps may be used to anonymize one item of patient sensitive information:
41. for each item of patient sensitive information
42. check if this information is already anonymized by looking up the records of the database
43. if yes, directly use the already anonymized code
44. else, generate a new random number ensuring the new random number does not already exist (48) by checking the database (49)
45. add prefix and type to the random number to form the anonymized code
46. replacing the sensitive information with the anonymized code
47. keeping the correspondence relationship between the sensitive information and anonymized code securely in the database

The system keeps the correspondence relationship between the-sensitive information and the anonymized code in the database. It may also provide a method to reveal the information before anonymization by looking up the database, but this method is preferably only used internally.

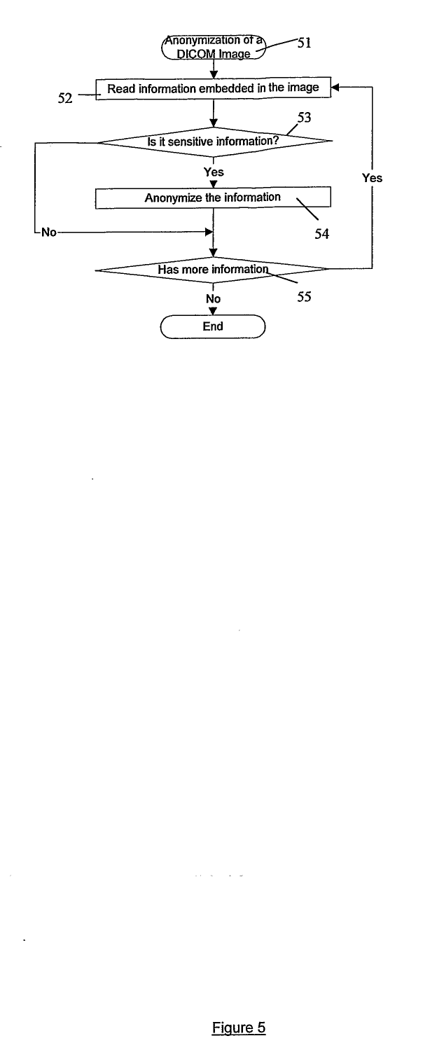

As shown in FIG. 5, after a DICOM image is loaded and stored in the database, the system automatically will anonymize it by replacing all sensitive information in the DICOM fields (51).

Sensitive information may include, but is not limited to:
Patient's name
Patient ID
Other patient's names
Other patient IDs
Patient's birth name
Patient's address
Patient's telephone numbers
Patient's mother's birth name
Region of residence
Country of residence
Military rank
Branch of service
Patient comments
Referring physician's name
Referring physician's address
Referring physician's telephone numbers
All other person names

The following steps are then used:
52. read the information embedded in the image
53. for each information determine if it is patient sensitive information
54. anonymize the sensitive information using the process described above in relation to FIG. 4
55. repeat the process until there is no more information

By using this anonymization method, no patient-sensitive information is disclosed, but the generator can obtain the information.

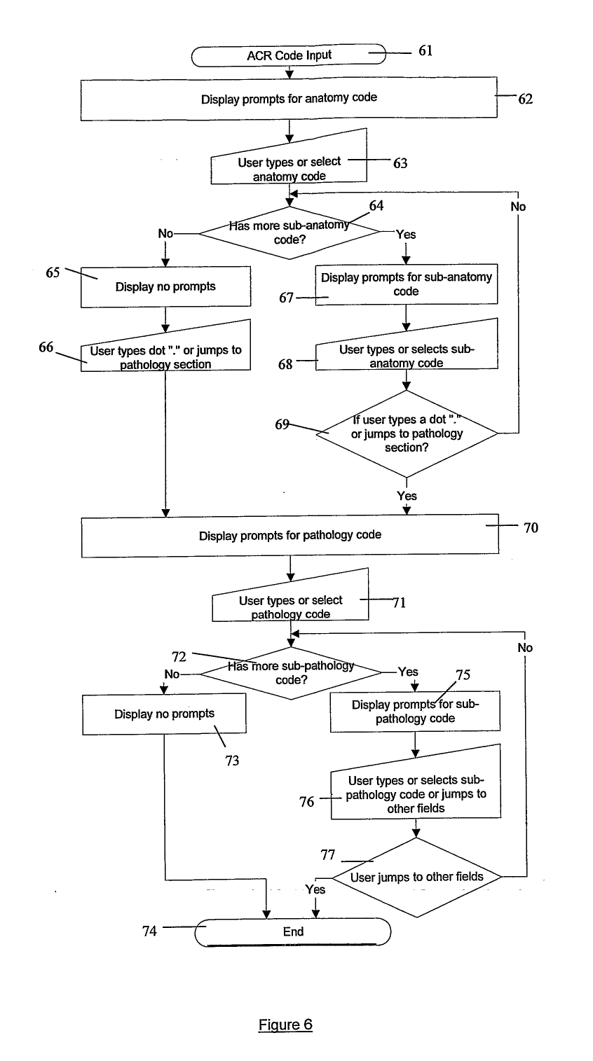

As shown in FIG. 6, useful information such as, for example, patient name, ID, sex, age, race, and so forth, may need to be inserted into the database 1. Significant images may also be selected and inserted into the database 1. They may also be deleted and re-ordered.

Author information and affiliation information may be retrieved automatically from the database 1 and then inserted into the teaching file database record.

A user interface 5 is provided to enter other necessary information such as copyright information, title, difficulty level, access permission, publishing date, reviewer, abstract, keywords, clinical findings, image findings, radiological codes, diagnosis, diagnosis groups, pathology of condition, imaging of condition, differential diagnosis, similar cases, quiz and references, and so forth. ACR coding system is used in the Teaching File and Research Dataset record. An ACR code has the following format:
<aaaa>. <pppp>
Where <aaaa>is the anatomy part, and <pppp>is the pathology part. They are digits from 0 to 9.

The ACR code is input (61) by user remembering and inputting the radiological codes or by the system guiding the user to input the ACR code step-by-step, or digit by digit. At each step, the system prompts the user with only the possible digits at the current position and the text of corresponding meanings. The first prompt (62) is for the anatomy code. After the entry or selection of the anatomy code (63), a query is raised to determine if there are sub-anatomy codes (64). If not (65), the next section is the pathology section (66). If yes, a further prompt is raised (67) and the relevant data is entered or selected (68). This may be repeated until the pathology section is entered (69) whereupon the system prompts for the pathology code (70). Upon the relevant pathological data being entered or selected (71) the system enquiries if there are more sub-pathology codes (72). If not, there are no more prompts (73) and the process ends (74). If yes, a prompt is raised (75) and the relevant data entered or selected (76). Steps 72, 75 and 76 may be repeated until other fields are selected (77), and the process ends (74).

Based on the database record generated in step 34 of FIG. 3, a teaching file or research dataset complying with the MIRC schema in XML format may be created. The teaching file or research dataset may also be previewed while editing, and it may be reloaded for modification.

A significant image inserted into the teaching files has two forms: a thumbnail, and a full image. The thumbnail image may be in JPEG format, and the full image may be in its original format or JPEG format.

The case record and the XML file together with significant images (thumbnails and full images) may stored permanently in the database in step 36 for later access. Later access may be for indexing, searching and retrieving.

The teaching files and research datasets stored in the database 1 may be indexed in various categories for searching purposes in step 37. The index categories may include title, abstract, keywords, authors, affiliations, contacts, patient information, radiological codes, image format, image compression status, image modality, anatomic location, and so forth.

Internet based searching mechanisms are provided in step 38. There may be two types of searching mechanisms: internal searching and external searching. For internal searching, patient sensitive information is exposed, whereas for external searching, this information is anonymized as is described above.

Computer useable medium comprising a computer program code that is configured to cause a processor to execute one or more functions to perform a method for retrievirig medical images from various sources and in different formats, to enable the creation of teaching files and research datasets, for the building of a personal medical image library, the method comprising:
(a) retrieving a plurality of medical images from various sources;
(b) storing the plurality of medical images in a database;
(c) generating a database record for the teaching files and research datasets;
(d) generating the teaching files and research datasets file;
(e) saving the teaching files and research datasets into the database; and
(f) generating at least one index of the teaching files and research datasets.

Whilst there has been described in the foregoing description preferred embodiments of the present invention, it will be understood by those skilled in the technology that many variations or modifications in details of one or more of: design, construction and operation, without departing from the present invention.

1. A method for retrieving medical images from various sources and in different formats, to enable the creation of teaching files and research datasets, for the building of a personal medical image library, the method comprising:
(a) retrieving a plurality of medical images from various sources;
(b) storing the plurality of medical images in a database;
(c) generating a database record for the teaching files and research datasets;
(d) generating the teaching files and research datasets file;
(e) saving the teaching files and research datasets into the database; and
(f) generating at least one index of the teaching files and research datasets.

2. A method as claimed in claim 1, further including a searching mechanism for searching the teaching files and research datasets.

3. A method as claimed in claim 1, wherein the medical images are from at least one discipline selected from the group consisting of: radiology, nuclear medicine, dermatology, pathology, ophthalmology, cardiology, neurology, endoscopy, angiography, biomedicine, ECG, EEG, and EMG.

4. A method as claimed in claim 1, wherein the method is in accordance with MIRC schema.

5. A method as claimed in claim 1, further including anonymizing patient sensitive information, the patient sensitive information being able to be revealed to a generator of the teaching files and research datasets.

6. A method as claimed in claim 5, wherein the patient sensitive information is not revealed publicly.

7. A method as claimed in claim 5, wherein the anonymization process includes the replacing of each item of the sensitive information with an anonymization code.

8. A method as claimed in claim 7, wherein the anonymization code includes a prefix, a randomly generated number and a type.

9. A method as claimed in claim 8, wherein the prefix is a short string of characters representing the generator of the sensitive information; and the type represents nature of the sensitive information.

10. A method as claimed in claim 7, wherein a check is first performed to determine if the item of sensitive information has previously been anonymized and the anonymization code previously generated; and, if yes, retrieving and using the previously generated anonymization code.

11. A method as claimed in claim 5, wherein the sensitive information includes one or more items selected from the group consisting of: patient's name, patient ID, other patient's names, other patient IDs, patient's birth name, patient's address, patient's telephone numbers, patient's mother's birth name, region of residence, country of residence, military rank, branch of service, patient comments, additional patient history, referring physician's name, referring physician's address, referring physician's telephone numbers, and all other person names.

12. A method as claimed in claim 1, wherein, in step (c), ACR codes are entered as a result of system prompts.

13. A method as claimed in claim 12, wherein the ACR codes are used for the at least one index of the teaching files.

14. A method as claimed in claim 1, wherein indexing is by at least one selected from the group consisting of: title, abstract, keywords, authors, affiliations, contacts, patient information, radiological codes, image format, image compression status, image modality, anatomic location, and ACR codes.

15. A method as claimed in claim 2, wherein, for internal searching, patient sensitive information is revealed, and for external searching patient sensitive information is anonymized.

16. A method as claimed in claim 1, wherein after each medical image is retrieved in step (a) it can be viewed before being stored.

17. A method as claimed in claim 1, wherein all medical images are kept in their original format once retrieved.

18. A method as claimed in claim 17, wherein the formats include at least one selected from the group consisting of AVW, HDR/IMG (Analyze format:
version 8.0 and 7.5), BMP (Windows Bitmap format), DICOM (Digital Imaging and Communications in Medicine), GIF, JPEG, JPEG 2000, PNG, PNM, PPG, RGB, RGBA, SGI, TIFF, AVW, HDR/IMG (Analyze format: version 8.0 and 7.5), Animated GIF, MIRA, Muti-sliced TIFF, MOV, AVI, MP3, RM, and Waveform for ECG, EEG, EMG.

19. A method as claimed in claim 18, wherein for two-dimensional medical images, two additional JPEG images are generated for ease of browsing using a web browser; and for other image formats, an additional thumbnail image may be generated.

20. A method as claimed in claim 19, wherein the two additional JPEG images are of the same size as thumbnail images.

21. Apparatus for retrieving medical images from various sources and in various formats for creating at least one teaching file and research dataset; the apparatus including a database, an image retrieval interface able to retrieve medical images from various sources and in different formats, an MIRC server, a server, and a graphic user interface for operation on a user's machine.

22. Apparatus as claimed in claim 21, wherein the database is a relational database for storage of all required information, including: database tables;
database indexes; database scripts; and pointers to the medical images, teaching files and research datasets.

23. Apparatus as claimed in claim 21, wherein the server serves requests received from a user via the graphic user interface on a user's machine; the graphic user interface being for providing access functions and file editing functions.

24. Apparatus as claimed in claim 21, wherein the image server includes at least one selected from the group consisting of: a two dimensional image loader, a three dimensional image loader, a multi-media loader and a telemetry loader.

25. Apparatus as claimed in claim 24, wherein the two-dimensional image loader is for retrieving two-dimensional still images.

26. Apparatus as claimed in claim 24, wherein the three-dimensional image loader is for retrieving three-dimensional still images.

27. Apparatus as claimed in claim 24, wherein the multi-media loader is for retrieving multi-media files.

28. Apparatus as claimed in claim 24, wherein the telemetry loader is for retrieving telemetry data.

29. Apparatus as claimed in claim 21, wherein the graphic user interface includes a PMIL client as a user interface able to run in a web browser or as a stand alone application on a user's machine, and provides MRIC editing functions.

30. Apparatus as claimed in claim 21, wherein the server includes an MIRC storage for providing an MIRC file storage service for the database and for the user's machine.

31. Apparatus as claimed in claim 30, wherein the MIRC server further includes an MIRC query to provide queries as defined by the MIRC scheme.

32. Apparatus as claimed in claim 21, wherein the at least one teaching file is in accordance with a Medical Imaging Resource Centre standard.

33. Apparatus as claimed in claim 21, wherein the formats include at least one selected from the group consisting of: AVW, HDR/IMG (Analyze format: version 8.0 and 7.5), BMP (Windows Bitmap format), DICOM (Digital Imaging and Communications in Medicine), GIF, JPEG, JPEG 2000, PNG, PNM, PPG,
RGB, RGBA, SGI, TIFF, AVW, HDR/IMG (Analyze format: version 8.0 and 7.5), Animated GIF, MIRA, Muti-sliced TIFF, MOV, AVI, MP3, RM, and Waveform for ECG, EEG, EMG.

34. Apparatus as claimed in claim 21, wherein all medical images are kept in their original format once retrieved.

35. A method as claimed in claim 33, wherein for two-dimensional medical images, two additional JPEG images are generated for ease of browsing using a web browser; and for other image formats, an additional thumbnail image may be generated.

36. A method as claimed in claim 35, wherein the two additional JPEG images are of the same size as thumbnail images.

37. Computer useable medium comprising a computer program code that is configured to cause a processor to execute one or more functions to perform the method of claim 1.
